(19) United States
(12) Patent Application Publication
(10) Pub. No.: US 2002/0186180 A1
(43) Pub. Date: Dec. 12, 2002

(54) Hands free solar powered cap/visor integrated wireless multi-media apparatus

(76) Inventor: William Duda, Bricktown, NJ (US)

Correspondence Address: William Duda, 43 Wood Ave., Brick town, NJ, 08724, US

(21) Appl. No.: 10/036,871

(22) Filed: Nov. 29, 2001

Related U.S. Application Data
(60) Provisional application No. 60/253,996, filed on Nov. 30, 2000.

(51) Int. Cl. G09G 5/00

(52) U.S. Cl. 345/8

(57) ABSTRACT

A apparatus whereby the functional electronics components of popular consumer communications and entertainment products can be repackaged in a molded plastic module that would be mounted underneath and follow the contour of the visor of a head wearable cap/visor providing the user with a hands free, continuous power, virtually invisible multi-media capability. The module would feature, a drop down visual display, drop down camera lens for low resolution digital photography, rechargeable battery, stereo speakers and earphones, a microphone and microphone boom, manual push button controls and LED indicator lights, input/output jacks, and an interactive voice capability. A flexible solar cell and antenna would be mounted on the upper surface of the head wearable cap/visor providing the wireless link and continuous power to the electronics module. All components would be secured to the head wearable cap visor via two active pins that protrude from the upper surface of the electronic module, pierce the visor, and mate up with the solar cell and antenna on the upper surface of the visor.

This application claims the benefit from previously filed provisional patent application No. 60/253,996, filed Nov. 30, 2000, titled Hat/Visor integrated multi-media system HIMMS.

### BACKGROUND OF THE INVENTION

1. Field of the Invention

This invention relates to the field of wearable hands free solar powered cap/visor integrated communications and entertainment devices and more particularly to an apparatus that is practically invisible, applies voice recognition and heads up display technology, and applies to hands free integration of combinations of popular commercial hand held products to include cell phones, personal communications devices, beepers, FM radio receivers, GPS receivers, voice recorders, organizers, limited internet, digital photography and video recording, limited internet, and broadcast TV reception.

This invention relates to the modular systems integration of several existing and proven communications and entertainment technologies with a head wearable cap or visor resulting in a compact, lightweight, integrated, hands free, manual or voice activated, heads-up (digital) displayed, solar powered, all weather personal multi-media communications/entertainment system, whose baseline functional capability could include but not be limited to combinations of the following electronics capabilities; FM radio reception, digital music (MP3) playback, cell phone, beepers, voice reorders, personal two way communications, organizer, cell phone, limited internet, GPS, and potentially broadcast TV reception. At the high end of this inventions capability, the system could be configured for low resolution digital photography, video recording and wearable computing. The Head wearable cap/visor Integrated Multi-Media System could be made up of discrete media functions identified above or combinations of the above-mentioned communications and entertainment media, depending on the user's preferences and the appropriate digital electronic circuit packaging scheme.

2. Description of Prior Art

Presently inventors and manufacturers have developed a wide variety of hands free and wearable communications and electronics devices. Ruppert ET AL discloses in U.S. Pat. No. 6,236,969 dated May 2001, a wearable telecommunications apparatus with voice/speech control features, based on a concept of a self contained telephone headset that includes an integral antenna, power supply, on board electronics and circuitry for RF and IF communications. The apparatus is held in place via a headband, and uses voice recognition technology as a prominent feature. The system runs off of battery power which would call for replacement batteries or recharging. The system would have to be placed on the users head when operating and otherwise be carried in some sort of case or container when not in use. My invention is always in place, practically invisible, completely innocuous when operating or stowed, solar powered, RF safe by virtue of antenna location, and offers the user a much wider range of consumer communications/entertainment capabilities.

In U.S. Pat. No. 5,796,374, issued on Aug. 18, 1998, Cone ET AL proposed a wearable support for an image display system that was to be worn on a users head. The principal application called for a head-hugging member made of a multi-elastic material that contained a rigid bill that would support an image display module. A separate image-generating module would be strapped to the operator's belt or otherwise carried. While this patent had little in common with my proposed device, this patent was of interest because an alternate embodiment showed a baseball cap as the head hugging member with the image display device mounted on the rim using a through the rim set of mirrors and prisms to get images from the image display device to the users eye.

Most of the media functions identified above have been available for many years first in bulky analog configurations, then in discrete downsized digital packages. Across the board, all of the communications/entertainment devices were historically designed for individual functionality, to be hand held, battery powered, stored in pockets, belt clips and carrying cases until used. Recently, some manufacturers have integrated cell phones with limited internet, MP3 playback and beeper capabilities, and those design advances have proven to be popular with consumers. Once again, as manufacturers further downsized the electronics packaging, and integrated over several important communications or entertainment functions, the design baselines still had the consumers holding the device when in use, storing the device in inconvenient locations when not in use, and changing or recharging batteries. The consumer could scarcely carry and operate more than one or two of the discrete media systems, and could never think of operating them during in element weather. Wire entanglements were and continue to be prevalent for the earphones. Cell phone antennas were radiating RF energy to close to the ear canal raising medical concerns. Consumers were driving with one hand while holding a cell phone with the other, causing an inordinate amount of motor vehicular accidents, resulting in many localities passing strict ordinances and stiff fines against operating cell phones while driving. The prior art was always obtrusively visible when operated by the user, and invariably had to be stowed in some sort of a carrying case when not in use. The electronics module of this invention is always cleverly hidden in plain site beneath the user's cap/visor visor and always available at a moments notice for operation without the slightest inconvenience to the user/operator.

### SUMMARY OF THE INVENTION

By means of the present invention, consumers will have access to a device that affords them an integrated complement of communications and entertainment features in a wearable, hands free, solar powered, voice activated package that is completely innocuous whether in use or stowed. The device offers advantages in antenna radiation safety and comfort and does not require carrying cases or storing devices when not in use. The solar cell will provide continuous power to the electronic module precluding the need for replacing batteries or recharging the electronic module via an adaptor. The visual display can provide a host of information to the user, to include, operational menu's, limited internet data, hands free digital photography or video, hands free position locating (GPS), and hands free broadcast TV.

It is a further object of this invention to provide the consumer with an apparatus comprised of the electronic components of existing communications and entertainment products whose features are integrated and repackaged into the electronics module and worn in operation or stowed throughout the day without any inconvenience to the user or without having the user display any unsightly electronic hardware. Many cell phones on the market today feature voice activation, personal communications, beeper and other functions. The cell phones are very light and the hand held devices are very small. The electronics circuitry within the hand held cell phones could very easily be repackaged in the electronic module for the apparatus that I am proposing. The same holds true for had held GPS receivers and TV's. The hand held packaging has been vastly reduced in size and the quality of the diminutive displays has been enhanced, implying the electronics designs for these two products are prime candidates for repackaging into the electronics module of the apparatus proposed herein.

These and other objectives of the present invention are achieved with this hands free wearable baseball cap integrated multi-media apparatus configured with the electronics components of popular consumer communications and entertainment devices. The packaging of the multi-media apparatus components above and below the rim of a baseball cap fixes these components to the cap and provides unprecedented utility to the user/operator regarding the three major components of the multi-media apparatus, the electronics module, the solar cell and the antenna. This invention is the first to present an everyday wearable platform for a solar cell large enough to sustain the communications and entertainment electronics components involved herein—the baseball cap rim. This invention provides a fixed mounting location for the antenna with both a active and stowed position, far enough from the ear canal to preclude the RF health issues that concerned hand held cell phone users. This invention packaged the electronics components underneath the rim of the baseball cap making that assembly virtually invisible to the user and anyone else unless the operator uses the display or the microphone boom for private conversations. When not in use, all components of the multi-media apparatus are stowed on the baseball cap and more or less undetectable to the consumer. At any point in time if the consumer needs to make a call, listen to FM stereo or MP3, take a digital still photograph, all it takes is touching the power button, put one or both earphones in the ears, drop the display, make selections via voice commands, stow the display and enjoy the conversation or music entertainment.

### OBJECTS AND ADVANTAGES

The intent of this invention is not to redesign the electronics subassemblies involved in the two way communications devices, FM radio, beeper, cell phone, etc. function, but to continue to capitalize on advances in digital technology and downsize, integrate, repackage those subassemblies into a single state of the art, hands free, solar powered, manual/voice activated, head-up displayed personal multi-media System that could be mounted in a comfortable yet innocuous position on the consumer, whether active or inactive. The system would be modular in the regard that the basic building block would be any one of several media functions, like the FM receiver or personal communicator (walkie-talkie). That basic apparatus configuration would have all the system accessories like the solar cell, head up display, earphones, telescoping microphone, voice activation, etc. Adding features like the beeper, MP3 playback, cell phone, voice recorder, etc. would place more emphasis on the visual display and voice activation for normal operation. Volume controls across all functions could be via voice or manual activation on the system case. MP3 recorded features and cell phone capabilities could be added with the same voice activated controls and functional entries on the display menu. As many cell phones come equipped with some limited Internet access, that same feature can be made available via voice activation and the display. While I make constant reference to combinations of media features packaged to

Provide the user with entertainment, local/long distance communications, and data organization, each of these functions can be individually packaged and mounted in the electronics module.

This system would be much more functional than anything previously provided for the consumer market. Key advantages are, hands freedom, virtually invisible, no operational/stowed inconvenience, continuous power, foul weather safe, voice operation, visual display and the availability of any one of several media functions instantly, at any time, any place. Consumers could mix and match over a set of media functions and pick those communications/entertainment capabilities that best suit their needs. Parents could have the cell phone/personal phone/fm receiver/Cell phone combination, while their kids had the personal phone/beeper/MP3 player/FM receiver combination. Law enforcement officials would need the personal communication back to a base station, GPS, cell phone with Internet link to an information database. Communication restrictions while driving should be eliminated. Consumers could operate a vehicle with both hands on the steering wheel while using the voice activation software and calling up a name or a phone number. Radiation concerns are eliminated since the radiating element of the antenna is much further than the 2.5 inch “safe” distance. The entire package can be moved from one cap/visor to another. This opens up entirely new vistas for law enforcement, organized sports, manufacturing, camping, business, etc., etc. Areas where hand held, belt clipped, or shirt pocket stored communications weren't practical could easily be realized now and the applications are limitless.

### BRIEF DESCRIPTION OF THE ILLUSTRATIONS

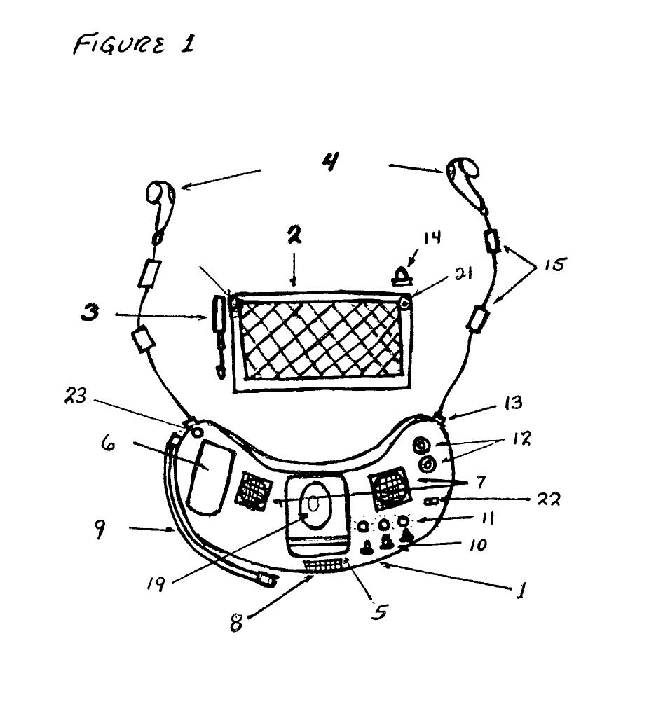

FIG. 1 is an exploded perspective view of all the major components of the hands free head wearable cap/visor integrated multi-media apparatus.

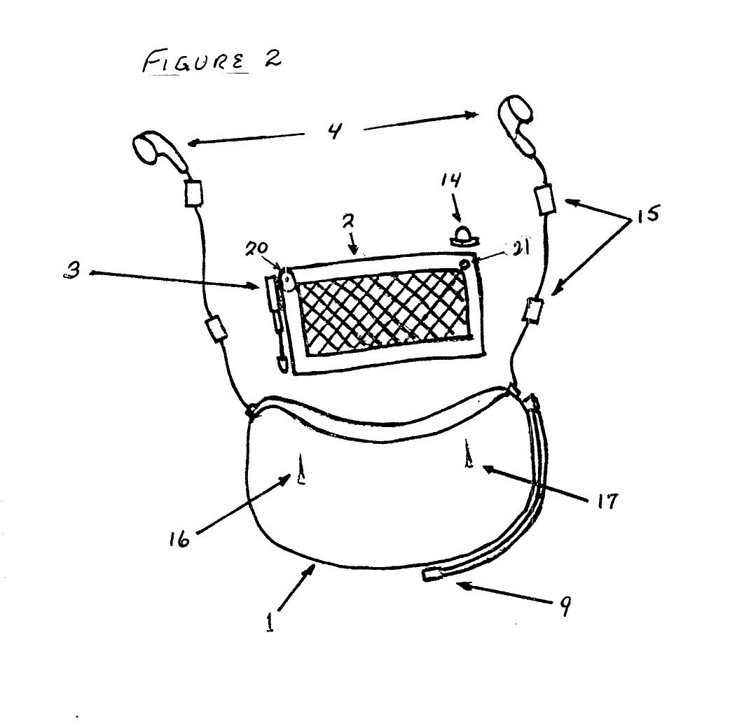

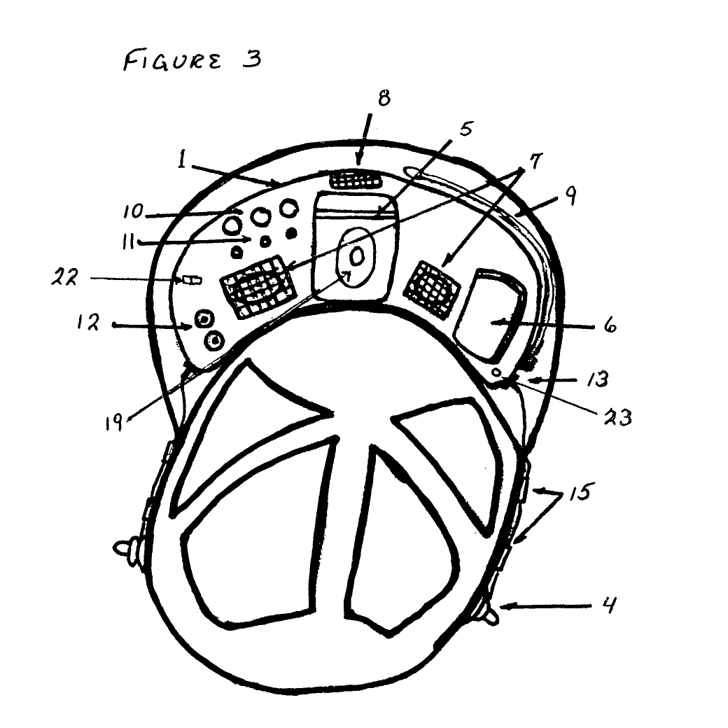

FIG. 2 is the same as FIG. 1, except that the electronics module has been inverted to illustrate the two active pins on the top of the module.

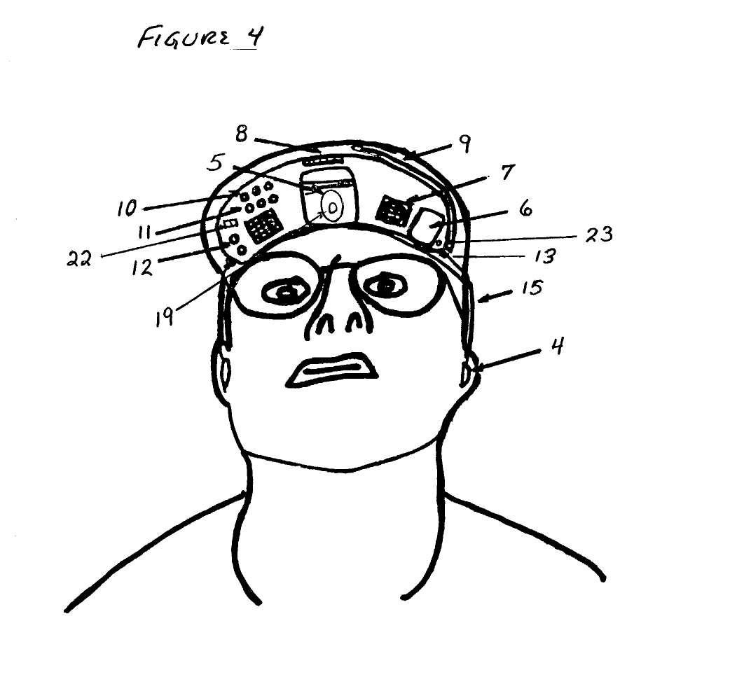

FIG. 3 is the underside of a head wearable cap with the electronics module mounted to the underside of the head wearable cap visor according to the preferred embodiment of the present invention.

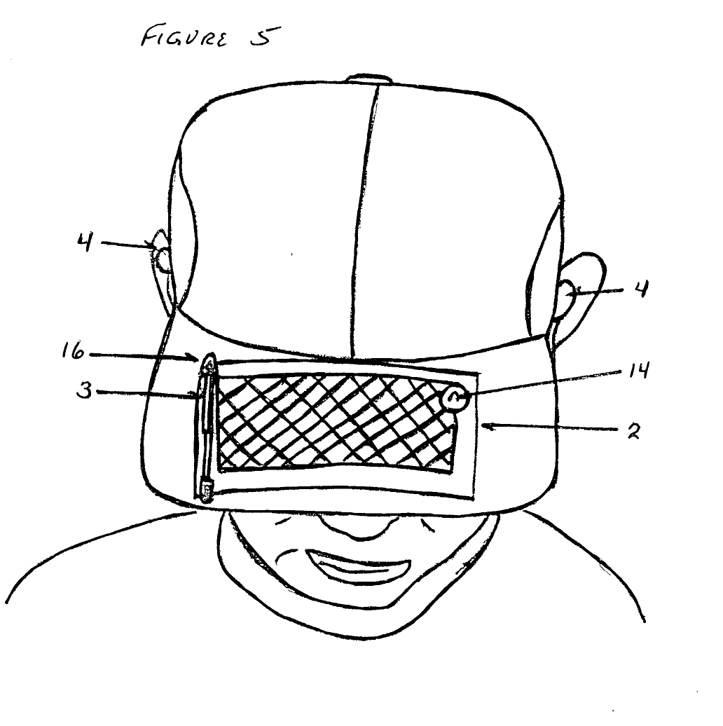

FIG. 4 has the electronics module mounted on the underside of the head wearable cap visor mounted on the head of a user, as that user tilts his head up.

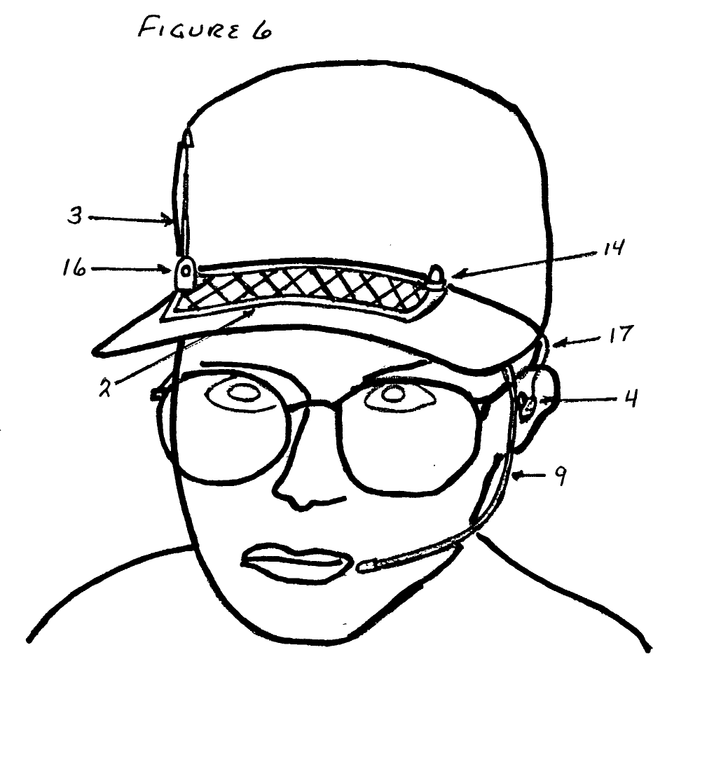

FIG. 5 is a representation of the solar cell and antenna mounted on the upper surface of the head wearable cap visor as the user tilts his head down.

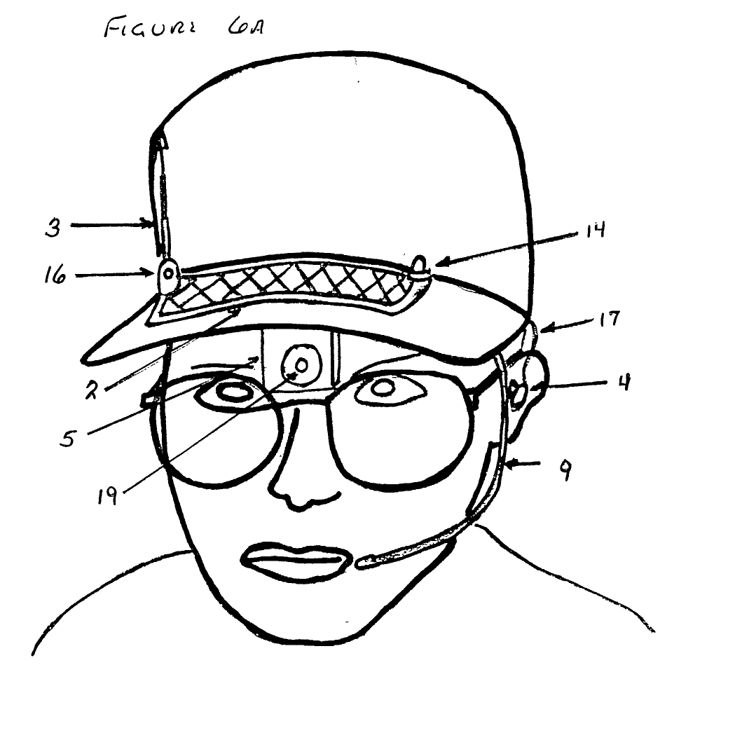

FIG. 6 is a straightforward view of the head wearable cap visor integrated multi-media system. Note that the visual display is stowed, and the electronics module is not visible.

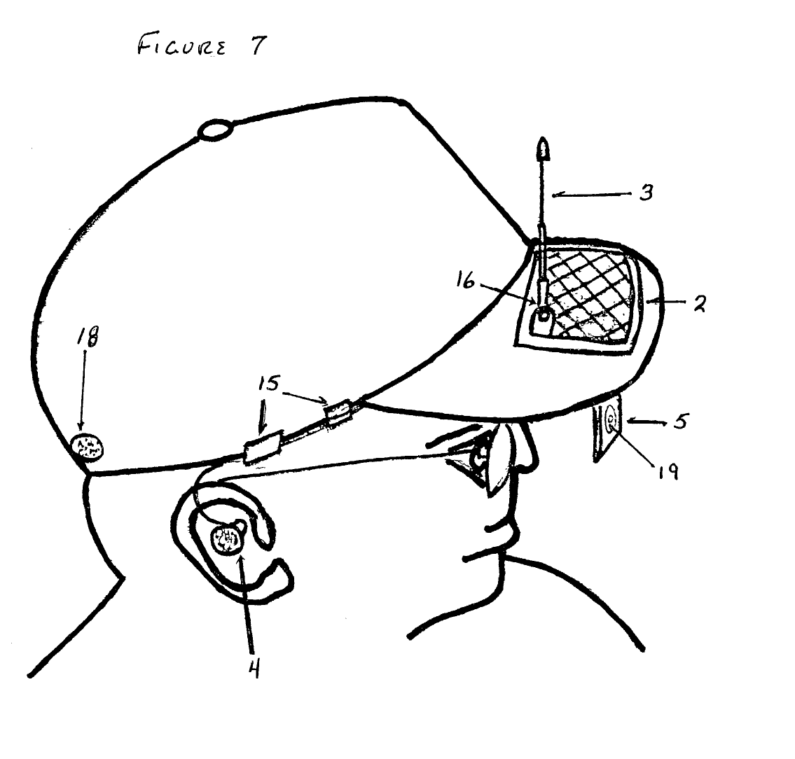

FIG. 7 is the right side exposure with the visual display deployed, the antenna active and the right earphone in use.

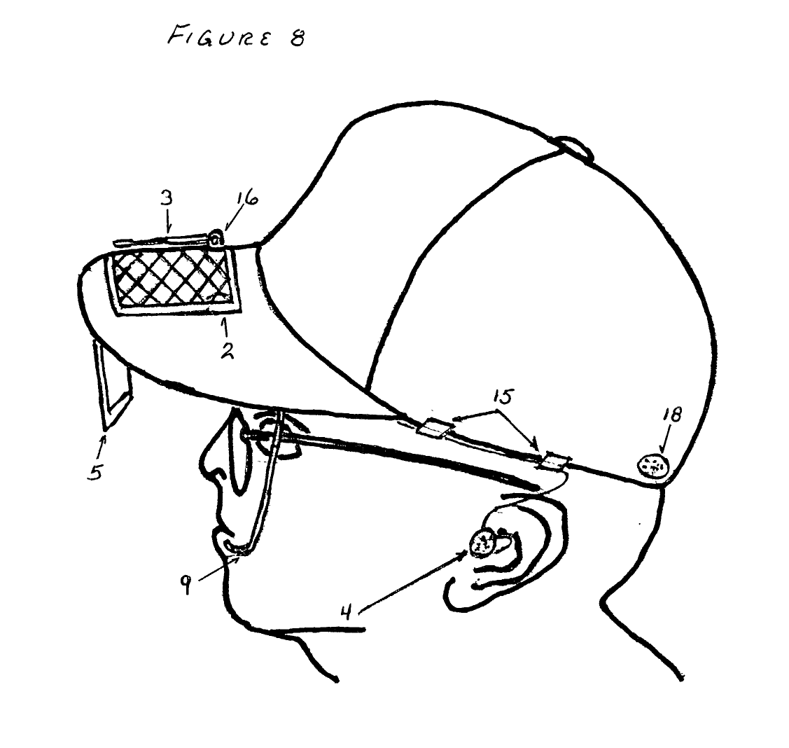

FIG. 8 is the left side view with microphone boom deployed and the left side earphone active.

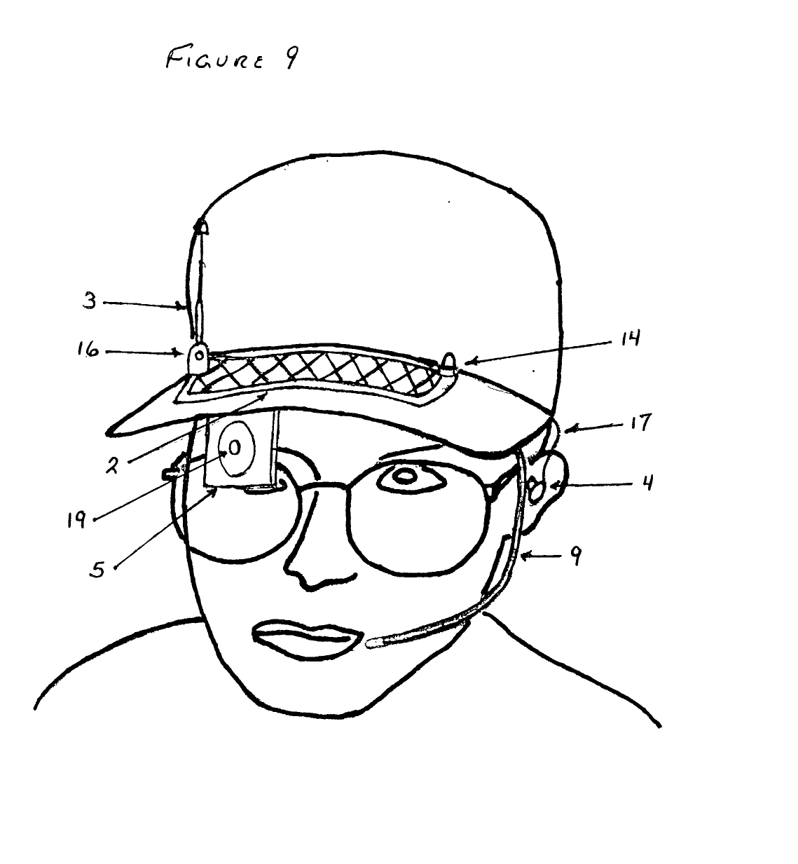

FIG. 9 is the frontal view with the visual display and camera lens deployed and active.

### DETAILED DESCRIPTION OF THE PREFERRED EMBODIMENT

In the interest of better presenting the intent of this invention, reference will now be made to a preferred embodiment, integrating the hands free head wearable communication and entertainment apparatus with the common baseball cap which is illustrated in drawings 3-9. Providing a detailed description of this invention against this embodiment should not represent a limitation in the scope of this invention as a head wearable apparatus. It is also the intent of this invention to convert clumsy and obtrusive hand held battery powered singularly functioned devices to the hands free, solar powered, always available yet innocuous apparatus by integrating and repackaging the existing technology into the electronics module. Detailed descriptions of the functional electronics used to support the communications and entertainment capabilities will not be offered.

FIG. 1 is a layout of all of the components of the hands free head wearable multi-media apparatus shown free of the cap/visor that it will typically attach to. The apparatus illustrated in FIG. 1 comprises a electronic module 1 that will house all of the systems electronics, a solar cell 2, that will continually recharge the systems battery, an antenna 3, for all wireless functions, and earphones 4 for private reception of communications or entertainment information.

The key element in this invention is the electronic module casing 1. It will be hollow and made up of a plastic material measuring approximately 6″ long, 2″ wide, by 0.5″ thick, shaped to the contour of the underside of the baseball cap or sun visor. It will be tapered to a narrow edge all along the front and side edges and come almost flush with the lower surface of the baseball cap visor. The electronic module case 1 will widen from front to rear and from both sides to the middle achieving a width of about 0.5 inches at the rear of the electronics module or where the cap visor meets the forehead of the wearer. There is ample space within the hollow case to configure the functional electronics components from individual or several integrated communications and entertainment devices and break out the wiring for input/output devices such as power, antennas, speakers, microphones, visual display, etc., to match up with similar devices on the electronics module.

The Key input output and control components found on the underside of the electronics module 1 of FIG. 1 are the visual display 5, the rechargeable battery 6, speakers 7, built-in microphone 8, privacy boom microphone 9, manual control buttons for power and menu scrolling 10, LED lights confirming operation 11, input/output jacks 12, the earphone jacks 13, volume control 22, earphone/built-in speaker switch 23 and the digital camera lens 19.

FIG. 2 is identical to FIG. 1, except that the electronic module has been flipped over showing the upper surface of the module displaying the active pins 16 & 17 that serve two major functions. First the pins connect to active electronics circuitry inside the electronics module. The pins have detachable pointed tips so they can be pushed through the baseball cap rim and mate up with two receptacles 20 & 21 in the side borders of the flexible solar cell 2 on the upper surface of the baseball cap rim. Once in place, the pointed tips of both pins screw off exposing electrical connections for the antenna and solar cell power cables. The left hand pin 16 provides the RF interface between the antenna 3 which screws onto the left side pin post 20, and the electronic module 1, anchoring the left side of the electronic module 1 and solar cell 2 to the baseball cap visor. The right hand pin 17 provides the power and recharging interface between the solar cell 2 and the electronic module 1. When the pointed pin top of right hand pin 17 is screwed off, power connections from the electronics module 1 are exposed and mated up with power wiring from the solar cell 2. The right side Pin post 17 is then capped with an electrical wire nut 14 which would anchor the right side of the solar cell 2 and electrical module 1 to the baseball cap visor.

FIG. 3 illustrates the underside of a baseball cap with the electronic module 1 mounted in place on the underside of the baseball cap visor. The stereo speakers 7 would be selected to maximize performance while minimizing size. The selection of the rechargeable battery 6 would be dependent on the communications/entertainment functions mounted in the electronic module. Rechargeable Lithium ion batteries would be a good selection supporting individual or combinations of cell phone, two way communications, beeper, FM stereo, MP3 digital playback, or voice recording. Repackaging different combinations of other functions such as GPS receivers, digital still or video cameras may take alternate rechargeable battery supplies. The built in microphone 8 would be sensitive enough to capture audio generated by the wearer of the Cap/Visor Integrated Multi-Media apparatus. The built in microphone 8 would be disabled if the wearer of the apparatus wanted some privacy and lowered the boom microphone 9 from the stowed position underneath the baseball cap visor, to close proximity to the wearers lips. The wearer would be able to lower the boom microphone to various settings through several ratchet settings where the boom microphone attached to the electronic module. The visual display 5 would take on various formats depending on the functions integrated into the electronic module 1. An LED display would be adequate to support individual or combinations of functions like cell phone, two way communications, beeper, FM stereo, MP3 stereo and voice recording. Functions like digital photography, video, or GPS graphics would take a digital display with the kind of resolution typically found in those hand held devices. The Input/Output jacks 12 would follow the industry standards for functions like loading MP3 digital stereo music or down loading digital still photographs or video. Push button power and scrolling control buttons 10 have associated LED status lights 11. The earphones 4 are shown attached to the Velcro stow tabs. The earphone wires run along side the bottom of the baseball cap via the clips 17, and patch into the electronic module at the earphone jack 13.

FIG. 4 represents a view of the electronics module mounted underneath the visor of a baseball cap on the head of a wearer with the wearer's head tilted upward. Both the display 5 and boom microphone 9 are in their stowed positions. The earphones 4 are inserted in the wearer's ears through the audio wires 15 which patch into the electronic module at the earphone jacks 13. As the apparatus is configured, the wearer could be listening to FM stereo or MP3 digital music, or by using the built-in microphone communicating via the cell phone or two-way communications function. Assuming those functional electronic assemblies are integrated into the electronic module.

FIG. 5 illustrates the mounting of the solar cell 2 and antenna 3 on the upper surface of the baseball cap visor. The solar cell 2 would be flexible in design and can use as much of the baseball caps visor as is necessary to keep the electronics module battery charged. The two receptacles where the active pins from the electronic module mounted beneath the baseball cap visor pierce the baseball cap visor and mate up with the solar cell 2 are shown under the electrical nut 14 and the antenna hinge 16. The solar cell receptacles are spaced so as to match up with the spacing of the active pins on the upper surface of the electronics module. The antenna 3 has been collapsed and hinged 16 down to the horizontal stowed position. Different antennas may be needed for different operational functions. The FM stereo and cell phone frequencies are in a different band than the GPS receiver and therefore would need different antenna elements for the appropriate reception. This illustration also shows the earphones 4 in place in the users ears.

FIG. 6 best illustrates the fact that in direct contact with the wearer, the electronics module is completely invisible. The antenna 3 has been raised, extended and is active, the user selected the more private form of communicating, so the boom antenna 9 is lowered (disengaging the built-in microphone) to the users lips, and the earphones 4 are in place in both of the wearers ears. As a practical matter, the wearer would have to first apply power to the electronic module by pressing the power button and see the corresponding LED light up. The wearer would then drop the display and through a series of manual actions or voice commands scroll through an operational menu, then manually or voice command scroll to a particular phone number, channel, or scroll through MP3 digital music selections or FM radio frequencies.

FIG. 6A is identical to FIG. 6, except that in this illustration, the visual display 5 with the digital camera 19 mounted on it's outer surface is deployed to it's vertical and active position.

FIG. 7 is the right side view of the apparatus with the display 5 lowered to the vertical position, the antenna 3 vertical and extended on the hinged antenna base 16, and the earphones 4 inserted in the wearers ears. The audio wires between the earphones and the earphone jack on the electronic module is secured to the baseball cap by the plastic clips 15. The outer surface of the earphones have Velcro material glued on. The inverted earphone is stowed on the Velcro pad that is pinned or glued to the back of the baseball cap 18. The Velcro pad is positioned on the baseball cap such that the earphone can be stowed on it when not in use or inserted into the ear when operational always leaving some slack in the audio wire.

FIG. 8 is the left side view of the cap mounted apparatus with the display 5 deployed and active, the boom microphone 9 deployed and active, the earphone in the ear canal and the antenna stowed, although it may be radiating in the horizontal position.

Additional/Alternative Embodiments

FIG. 9 illustrates the relocation of the visual display 5 with the Digital Camera 19 capability added to the outer surface. The display in the preferred embodiment was more centered in the electronic module, and in this case it is moved over the right eye.

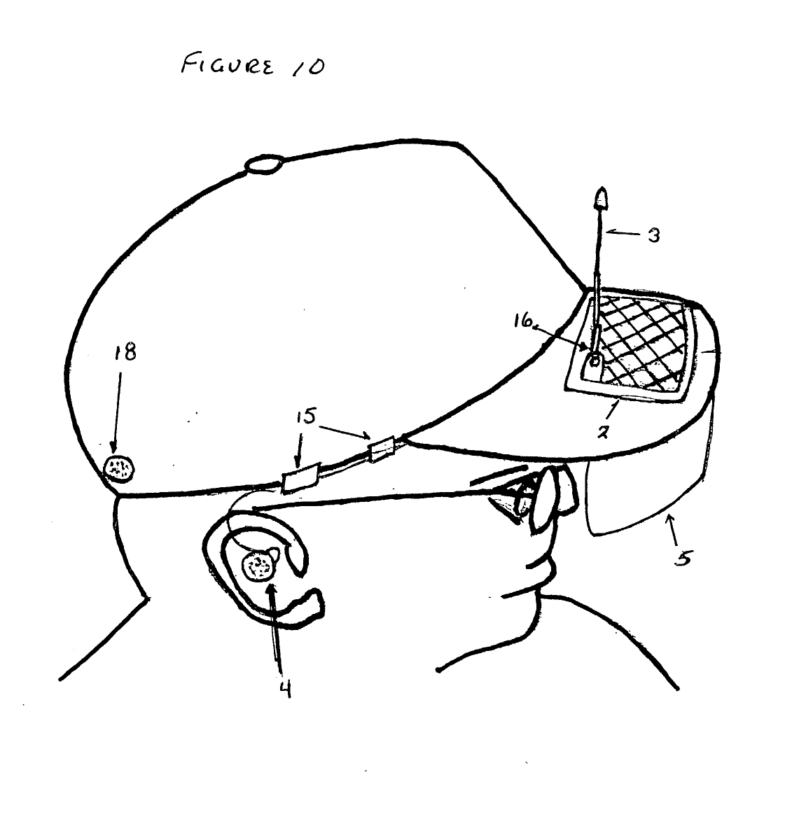

FIG. 10 illustrates the full face drop down display 5. In this case, the display would completely cover he bottom side of the electronic module and hinge down for viewing by both eyes. This display is practical for broadcast TV, or GPS map viewing. All of the electronics modules controls, built-in speakers, built-in microphones, I/O ports and batteries would have to be on the back side of this display or covered by the display when it is in it's stowed horizontal position. The technology is mature enough for that sort of a display and there are several products on the market today that provide this feature on eyeglass like rims which hang on the nose and over the ears.

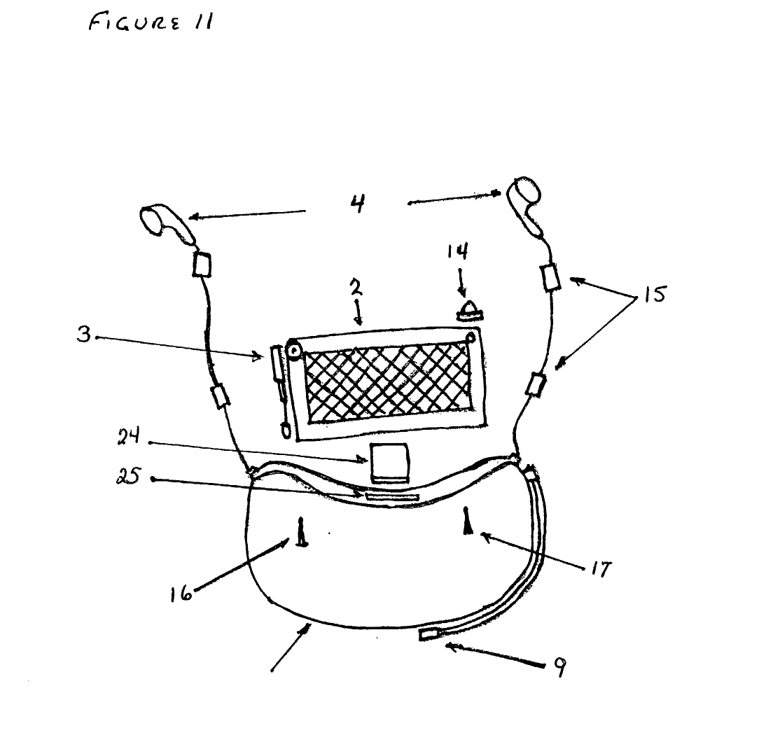

FIG. 11 illustrates the concept of having the electronics module configured with a port 25 that has an adapter into which digital memory cards 24 are plugged, each card having a different communication/entertainment function, or combinations of functions. The multi-media apparatus would then be programmed to perform in accordance with the functional card that happened to be plugged into the port.

Advantages

This patent document has repeatedly identified several clear advantages of the Hands Free Solar Powered Cap/Visor Multi-Media Apparatus, over the commercially available consumer counterparts available on the open market today. The hands Free Solar Powered integrated Cap/Visor Multi-Media Apparatus offers the wearer enhanced awareness, decreased amounts of electronic luggage that would ordinarily fill pockets, pocketbooks and belt loops and does not compromise the wearer's health, well being and safety, especially when the operator is communicating while

operating an automobile, boat, bicycle or any other form of transportation. Where the cell phone function alone is concerned, many localities are passing legislation precluding the use of hand held communications devices while operating motor vehicles, and as a result, the cell phone manufacturers are developing wired headsets for remoting the cell phone to a shirt pocket of belt buckle or cigarette lighter adapters for hands free operation while operating an automobile. The fundamental problem is still there, that the cell phone, batteries, headset, wiring, or adapter still have to be carried by the user, placed in position, communicated with, and then stowed until the next time that the need to communicate arises. Consumers do not wear headsets if they're not communicating, so headsets have to be constantly placed on the head of the operator and removed and stored somewhere. This invention precludes all of the above inconveniences and distractions and would never compromise the wearer's ability to control the steering wheel of a motor vehicle.

The antenna location clearly reduces or eliminates the radiation threat to the operator. Any concerns that the handheld cell phones may have generated by having to be held close to the ear to communicate are completely eliminated. Medical science has suggested that 2.5 inches was considered the safe distance for antennas radiating at the energy levels typically experienced by current cell phones. This design keeps the radiating element 6-8 inches away form the operator's head and ear canal, completely eliminating the threat.

The flexible solar cell also represents a formidable advance in this design since it allows for the availability of continuous power for both system operation and battery recharging. Solar cells are being used to charge some hand held cell phones but their charging capacity is generally limited to the size of the cell phone itself which in most cases are quite small. The size and charging capability of the solar cell can vary depending on the electronic payload within the electronics module to be supported, therefore, the dimensions and electronic characteristics of the solar cell can vary as long as the cell does not exceed the dimensions of the upper surface of the baseball cap/visor rim.

The fact that the electronics package is mounted below the baseball cap rim, provides a measure of environmental protection from foul weather elements such as light rain or drizzle, as well as snow. Hand held communications or entertainment devices should not be operated in foul weather.

The baseball cap/visor mounting location should also preclude any of the fumbling or dropping invariably associated with the handheld, pocket or belt mounted communications or entertainment devices. The wearer's pockets will not be cluttered with electronic devices, headsets, or wires. The wearer would never have to be concerned about breaking out, putting on equipment, communicating, stowing and repeating that cycle time and again. The apparatus proposed in this invention is always available and invisible in plain sight, never representing an inconvenience whether operating or stowed.

Other advantages focus on the use of the technological advances represented by the heads up display and voice activated technology. Developers of both of these technologies have made quantum leaps in integrating the necessary hardware and software into commercial products that can benefit from these advances in personal use technology. While some of the more elementary operational functions of the Integrated Multi-Media Apparatus may get away with manual operations, some of the more exciting and robust capabilities will not be able to do with out the drop down display and the voice activated capability.

Operation

The preferred embodiment for the Cap/Visor integrated Multi-Media apparatus is the baseball cap and the apparatus would first have to be installed. With the baseball cap positioned upside down on a table. The electronics module is measured for it's fit underneath the baseball cap visor. With the widest section of the electronics module positioned close to where the wearer's forehead, gentle pressure is applied so that the active pins 16 & 17 slowly and evenly penetrate the visor of the baseball cap. Once those pins penetrate the upper surface of the baseball cap visor, the solar cell 2 is placed on the upper surface of the visor in such a way that the electronic modules 1 active pins 16 & 17 pass through the two receptacles 20 & 21 in the borders of the solar cell. The active pin tips are then screwed off exposing active components for the antenna and solar cell interconnects. The antenna 3 and it's hinged swivel base 16 screws on to the left handed active pin post 16 completing the antenna interface with the electronic module and securing the left side of the electronic module and solar cell to the baseball cap visor. The right side active pin post 17 gets wired to the respective recharging leads of the solar cell 2 and a electrical nut 14 screws down on that post completing the electrical connections between the solar cell 2 and the electronic module 1 and securing the right side of the solar cell and electronic module to the baseball cap visor. Both earphone jacks are inserted into the connectors 13 at both sides of the electronic module 1, while the audio wires are secured to the bottom of the cap by the clips 15 that connect the earphones 4 to the electrical module 1. The earphones 4 have small Velcro patches on their outside and they mate up with the Velcro patches 18 pinned or glued to both sides of the baseball cap for stowing the earphones.

Once the apparatus is installed on the baseball cap, operation would depend on the communications/entertainment functions integrated into the electronics module. For the most part, the Cap/Visor Integrated Multi-Media Apparatus operations would be common to most communications/entertainment applications. All applications or functions would be design configured to operate in a manual or voice activated mode or combinations of both. The solar cell 2 would continually recharge the battery 6 which would apply primary power to the functional electrical components in the electronic module 1. Operation is initiated by depressing the power button in the series of control switches 10. Power can also be applied by dropping the display 5 from the stowed horizontal position, to the active vertical position. The display presents a menu of communication/electronic functions available in the electronic module and the wearer can scroll through that menu using the other two control buttons to scroll up or down, and select by double depressing the scroll button in quick succession on the desired function. The scrolling/selecting function could also be accomplished using voice commands to scroll up, down and select. The wearer's voice commands would be stored in the electronics modules internal memory, and the wearers voice commands would be received by the built in microphone 8, and processed, or if privacy is necessary, the wearer can lower the boom microphone 9, which automatically disables the built in mic. If the wearer then selects the FM stereo reception for listening pleasure, the antenna 3 would be raised to the vertical position and extended. The wearer can scan manually for the strongest FM signal or a desired FM station, using the same buttons 10 previously used for scrolling and selecting the functions on the functional display menu. The wearer can also use voice commands to have the FM receiver scan the FM band for the five strongest local FM signals and display them on the visual display for the wearers viewing and selection as necessary. Toggle switch 22 controls the stereo and all audio volume. The wearer can select to listen to the FM reception through the stereo speakers 7 or direct the FM reception to the stereo earphones 4 for private listening by selecting the earphones via switch 23. The MP3 digital music playback follows the same operational scenario as presented above for FM stereo reception, except that the MP3 files have to be loaded up into the electronic module via the Input/Output jacks 12. The digital selections show up on the display 5, and the wearer manually or through voice commands make and plays selections. The two way communications function can be selected from the display 5 start menu with the wearer manually or through voice interaction selecting a communication channel from the two way communication screen 5, setting the volume 22, selecting built-in microphone 8 vs. boom microphone 9, built-in speakers 7 vs. earphones 4 via switch 23, and setting the antenna 3 to the vertical position. Cell phone operation is much the same as for the two-way communications function presented above. The digital camera function applies the same digital photographic technology currently available in some of the Casio digital photograph capable wristwatches. While the displays discussed in the previous communications/entertainment functions were LED type for presenting data, the camera display would have to be constructed of some resolution of the picture element (PIXEL) technology currently available on the market. The camera lens 19 and some array of data storage PIXEL's are mounted on the back of the display cover. When the display 5 is lowered to the vertical level, and the digital camera 19 is selected manually using the scrolling control buttons 10 or via voice interaction, low-resolution digital still photographs are taken and stored in the electronic modules internal memory. The image that is about to be taken appears on the display screen. Those digital photos can then be down loaded to some other medium from the Input/Output jacks 12. The more complex the electronics packaging becomes (i.e. adding more sophistication to the digital camera, digital camcorder, etc.) the more the operation will depend on scrolling through and selecting menu functions using voice activated technology.

Shutting the system down would be a matter of hitting the power button to shut off power. The apparatus could still be functional with the display stowed assuming the wearer has mad all the display menu selections necessary to be communicating or listening to music. The solar cell should continue to recharge the internal battery. The antenna should be stowed to the horizontal position. The earphones should be attached to their velcro storage points, and the boom microphone (if deployed) should be moved up under the baseball cap/visor to it's stow position.

Conclusions, Ramifications and Scope

Accordingly, the reader can see that the Cap/Visor Integrated Multi-Media Apparatus brings a new era of esthetically pleasing, convenient, unobtrusive, innocuous, multi functional, communications/entertainment devices to the consumer. The components of the apparatus use the physical characteristics of the first embodiment, the baseball cap to the maximum extent possible in providing a communications/entertainment package that:

is readily available to the wearer at all times

eliminates the need for packing, carrying, storing, holding or applying electronic devices, headsets, wires,

eliminates the hand held and wired headset distractions allowing for enhanced awareness and focus when communicating while driving a motor vehicle,

will reduce incidents of dropped, lost or stolen electronic communication/entertainment devices since there will be no need to handle the devices once the Cap/Visor Integrated Multi-Media apparatus is on the wearer's head

is practically invisible to the casual observer,

provides a large rigid platform for the solar cell allowing for a variety of solar cell dimensions to match differences in electrical requirements as called for by different packaging of communications/entertainment electronics devices in the electronic module,

provides a mounting location the antenna that affords the wearer some measure of safety with regard to transmitted RF energy and the proximity of the antenna and the ear canal,

allows for foul weather operation with the electronics module located underneath the Cap/Visor,

offers multiple communication/entertainment functions in one package,

offers manual as well as voice activated controls,

offers built-in stereo speaker reception as well as privacy earphones,

offers a built in microphone for transmitting voice as well as a boom microphone when privacy is needed,

offers the hands free digital camera apparatus

offers the hands free digital video recorder apparatus

Although the description above contains many specificities, these should not be construed as limiting the scope of this invention but as merely providing illustrations of some of the preferred embodiments of this invention. Variations to the preferred embodiment are for example,

all of the Cap/Visor Integrated Multi-media components can be integrated into the cap/visor itself, as opposed to hanging the components underneath and on top of the visor. The Multi-Media integrated visor can then be sewn or other wise fastened to the cap and worn on the wearer's head.

the visual display presented in all of the illustrations of the preferred embodiment is shown in the center of the electronics module. It might better be placed to the right or left of center, so that when deployed to the vertical position, one eye could view the display while the other eye would continue to have an unobtrusive view of what is ahead of the wearer.

For some applications, like viewing GPS maps or broadcast TV channels, the entire bottom lid of the electronics module could hinge down providing a wide display for both eyes. The technology is mature enough for that sort of a display and there are several products on the market today that provide this feature on eyeglass like rims which hang on the nose and over the ears. All of the electronics modules controls, built-in speakers, built-in microphones, I/O ports and batteries would have to be on the back side of this display or covered by the display when it is in it's stowed horizontal position.

The electronics module could be configured with a port that has an adapter into which digital memory cards are plugged, each card having a different communication/entertainment function, or combinations of functions. The multi-media apparatus would then be programmed to perform in accordance with the functional card that happened to be plugged into the port.

Thus the scope of the invention should be determined by the appended claims and their legal equivalents, rather than by the examples given.

30 November 2001

U.S. Class:

Class:

search:

References Cited [Referenced by]

August 1998 Cone ET AL

Augist 1996 Quint ET AL

February 1992 Prescott

March 1991 Wells

May 2001 Ruppert ET AL

March 1993 Regen ET AL

November 1977 Silver

September 1977 Dukich ET AL

What is claimed is:

1. A head covering apparatus for receiving and transmitting electronic signals, the apparatus being adapted to engage the head of a wearer which comprises:
a cap portion formed of a material having a first stiffness characteristic such that the cap portion is adapted to conform flexibly to the head of the wearer;
a visor projecting from said cap portion, the visor having a second stiffness characteristic which is greater than the first stiffness characteristic of the cap portion, the visor including a upwardly facing surface, and a downwardly facing surface,
a solar cell which has receptors for solar rays which is not blocked from solar rays by the upwardly facing surface
an antenna which extends beyond the upwardly facing surface
an electronic module which is in electrical communication with the solar cell for receiving power from the solar cell and which is in electrical contact with the antenna for the purpose of passing a signal between the electronic module and the antenna.

2. The head covering apparatus according to claim 1 wherein the electronic module is attached to the adjacent portion of the visor.

3. The head covering apparatus according to claim 2 wherein the electronic module includes a transmitting component in electrical communications with the antenna
The electronic module further including a receiving component in electrical communications with the antenna
The electronic module further including at least one amplifier, modem, and switching component necessary for one or two way communicating
The electronic module further capable of capturing, processing, storing and managing digital data
The electronics module further including a visual display component for providing the wearer with menu options, digital and graphic data
The electronics module further containing a rechargeable battery
The electronics module further containing a built-in microphone for receiving and processing audible signals from the wearer and which is in electrical communications with the transmitter component
The electronics module further containing a boom microphone for receiving and processing audible signals from the wearer and which is in electrical communications with the transmitter component
The electronics module further containing built in speakers which are in electrical communications with the receiving component
The electronics module further containing earphones which are in electrical communications with the receiving component
The electronic module contains a voice activated component wherein the wearer can make operational selections via audible commands
The electronic module wherein input jacks are available for uploading digital data.
The electronic module wherein output jacks are available for downloading digital data.

4. The apparatus according to claim 1, wherein the electronics module is fitted with the functional electronics components of popular consumer products selected from the group consisting of; cell phones, beepers, personal communications devices, GPS receivers, FM radio receivers, MP3 recorders/players, voice recorders, organizers, limited internet reception, digital camera, broadcast TV reception, hand held computers and limited digital video recording.

5. The apparatus according to claim 1, wherein the electronics module is fitted with integrated combinations of electronics components of popular consumer communications and entertainment products selected from the group consisting of; cell phones, beepers, personal communications devices, GPS receivers, FM radio receivers, MP3 recorders/players, voice recorders, organizers, limited internet reception, digital camera, broadcast TV reception, hand held computers and limited digital video recording.

6. The apparatus according to claim 2, wherein the electronics module further includes a drop down display having a menu and wherein the electronics module has both a manual and a voice activated control means for initiating operation and selecting functions via manual and voice operated scrolling in response to appearing on drop down display.

7. The apparatus according to claim 1, wherein the lower surface of the visor has a contour and wherein the electronics module has a shaped contour which conforms to the contour of the underside of the visor, said electronics module is physically tapered at the forward edge and both sides, and expands to a width of approximately 0.5 inch adjacent to the cap portion which is adapted to engage the wearer's forehead.

8. The apparatus according to claim 1, wherein the electronics module has two active pins protruding from its upper surface, wherein each pin extends through and engages the visor and engages the solar cell and antenna on the upper surface of the cap visor for securing the electronics module to the cap visor, and for providing antenna and solar cell interconnections to the electronics module.

9. The apparatus according to claim 2, wherein the electronics module contains combinations of operator interface devices selected from the group consisting of a drop down information display, stereo speakers, manual push button controls with associated led indicators, audio controls, built-in microphone, drop down microphone boom, earphone jacks, input/output jacks, digital camera lens, and a rechargeable battery.

10. The apparatus according to claim 1, wherein the flexible solar cell is rated to support the electronics functions mounted in the electronics module.

11. The apparatus according to claim 1, wherein the upper surface of the visor has a contour and wherein the flexible solar cell has a contour which conforms to the contour of the upper surface of the visor.

12. The solar cell according to claim 11 wherein two receptacles are provided to capture two pins protruding from the upper surface of the electronic module.

12. The receptacles according to claim 12 serve to capture the two pins on the upper surface of the electronic module and therefore secure all components of the apparatus to the cap visor.

13. The receptacles according to claim 12, wherein the left side receptacle is insulated from the solar cell and provides connectivity for the RF antenna which when seated on the left side pin also provides a captivating function for the left side of the electronics module.

14. The receptacles according to claim 12, wherein, the right side pin provides the electrical connectivity between the solar cell and the electronics module and secures the right side of the electronics module to the baseball cap visor.

15. The apparatus according to claim 1, wherein the antenna is selected to support the wireless electronic functions integrated in the electronics module.

16. The antenna according to claim 10, wherein the antenna is mounted on the left side electronics module pin as said pin pierces the cap visor and passes through the solar cell.

17. The antenna according to claim 10, wherein said antenna should have a telescoping capability and have a hinged swivel base to operate in the vertical and stow in the horizontal position.

18. The apparatus according to claim 1, wherein the antenna also serves to anchor the left side of the electronic module to the head wearable cap visor.

19. The apparatus according to claim 1, wherein the electronic module has electrical jacks on both sides of the electronic module, said jacks provide connectivity for the earphones to the electrical module.

20. The apparatus according to claim 14, wherein the earphones have means for attachment to the head wearable cap above the users ears when not in use or stowed.

21. The apparatus according to claim 1, wherein the electronic module has an internal battery, said battery rated to be rechargeable by the solar cell and provide power to the electronic module during periods of little or no external light.

22. The battery according to claim 21, wherein the switch over from solar cell to battery power is automatic via a sensor that detects reduction in solar energy or reduction in available light, said switching will also preclude overcharging of the battery.

23. The apparatus according to claim 1, wherein the electronic module drop down display is designed to be activated when the user moves it from its horizontal stowed position, to the vertical activated position, Said drop down display would present the operator with the same information typically presented on the displays of the hand held communications and entertainment devices available today.

24. The display according to claim 18, wherein it's size, and mounting location on the electronic module and information presented depends on the functions available in the electronic module.

25. The apparatus according to claim 3, wherein the I/O jacks are configured to industry standards for loading MP3 digital music for play back by the operator, said jacks should also be able to accommodate the down loading of digital data that can be stored by the electronic modules internal memory.

26. An apparatus according to claim 3, wherein the built in microphone can pick up communications or control audio from the operator when privacy is not important, said built in microphone is disabled when the boom microphone is lowered from it's stowed position up against the head wearable cap/visor visor, to the lips of the operator, said boom microphone gives the operator some measure of privacy.

27. The apparatus according to claim 3, wherein a digital camera lens can be mounted on the lower surface of the digital display for the purpose of collecting digital data in the form of camera images, said digital images are captured via manual or vice recognition control.

28. The apparatus according to claim 1 wherein all of the components cited are built into and are an integral part of the head wearable visor together with the functional electronic components of selected electronic devices.

29. The apparatus according to claim 1, wherein a voice recognition circuit for recognizing voice input to the microphone and for performing a dialing, selecting or control operation based on voice.

30. The apparatus according to claim 1, wherein all components of the apparatus are integrated into the design of the visor, said visor then being attached to the cap.
